(19) United States
(12) Patent Application Publication
(10) Pub. No.: US 2007/0077405 A1
(43) Pub. Date: Apr. 5, 2007

(54) Inorganic/organic-filled styrenic thermoplastic door skins

(75) Inventor: Michael L. Jackson, Grosse IIe, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation

(21) Appl. No.: 11/241,496

(22) Filed: Sep. 30, 2005

(51) Int. Cl. B32B 7/02

(52) U.S. Cl. 428/216

(57) ABSTRACT

An article comprising a frame having an outer periphery with a multilayered, substantially planar skin secured thereto that is exposed to various environmental conditions is disclosed. The skin comprises a first layer exposed to the environmental conditions and a second layer shielded from the environmental conditions by the first layer. The first layer is substantially free of organic and/or inorganic fillers and comprises a copolymer of at least one ethylenically unsaturated monomer, at least one aromatic vinyl compound, and at least one acrylic ester elastomer. The second layer comprises a terpolymer of at least one ethylenically unsaturated monomer, at least one butadiene, and at least one aromatic vinyl compound and has at least one filler is dispersed therein in an amount of from about 5 to about 35 percent based on a total weight of the second layer.

### BACKGROUND OF THE INVENTION

1. Field of the Invention

The subject invention relates generally to an outdoor article that is exposed to various environmental conditions, and more specifically to a multilayered, substantially planar skin secured to a frame of an outdoor article.

2. Description of the Prior Art

Outdoor articles, such as exterior doors, have previously been manufactured from wood, metal, and fiberglass materials. These outdoor articles are exposed to various environmental conditions, such as high and low temperatures and high and low humidity. Therefore, these outdoor articles must be able to withstand such environmental conditions. This is especially true for different regions that experience a greater variance in the environmental conditions. For example, some regions have winter seasons that are extremely cold and dry and summer seasons that are extremely hot and humid. These materials have been shown to perform adequately in these changing environmental conditions. However, it is expensive to manufacture these outdoor articles with these materials and these materials may not be best suited for these outdoor articles exposed to these varying environmental conditions.

Recently, multilayered skins have been used to form these outdoor articles in regions that have mild environmental conditions and that do not suffer from extreme changes. The multilayered skin is substantially planar and comprises a first layer disposed onto a second layer such that the first layer shields the second layer from the environmental conditions. The first layer comprises a copolymer of acrylonitrile, styrene, and an acrylic ester elastomer and the second layer comprises a terpolymer of acrylonitrile, butadiene, and styrene. However, these outdoor articles do not provide adequate performance when exposed to changing environmental conditions that are encountered in many regions. For example, these outdoor articles have a tendency to warp and do not provide the desired physical properties, such as stiffness and coefficient of linear thermal expansion.

As such, it would be advantageous to provide an outdoor article that is relatively inexpensive to manufacture, while also providing comparable physical attributes to wood, metal, and fiberglass materials. Further, it would advantageous to provide the multilayered skin that withstands and that performs well in changing environmental conditions.

### SUMMARY OF THE INVENTION AND ADVANTAGES

The subject invention provides a multilayered, substantially planar skin secured to an article that is exposed to various environmental conditions. The skin comprises a first layer exposed to the environmental conditions and a second layer shielded from the environmental conditions by the first layer. The first layer is substantially free of organic and/or inorganic fillers and comprises a copolymer of at least one ethylenically unsaturated monomer, at least one aromatic vinyl compound, and at least one acrylic ester elastomer. The second layer comprises a terpolymer of at least one ethylenically unsaturated monomer, at least one butadiene, and at least one aromatic vinyl compound and has at least one filler dispersed therein in an amount of from about 5 to about 35 percent based on a total weight of the second layer for providing increased resistance.

The subject invention also provides the article comprising a frame having an outer periphery disposed in a plane. The multilayered, substantially planar skin is secured to the frame and has a total thickness of from about 20 to about 150 mils.

The multilayered, substantially planar skin is able to withstand wide changes in various environmental conditions and performs acceptably as compared to wood, steel, and fiberglass materials. The article having the skin secured thereto is less expensive to manufacture than the articles formed from wood and fiberglass. The article of the subject invention provides higher surface qualities than is obtainable with articles formed from steel at reasonable manufacturing costs. Further, the skin undergoes limited or reduced, if any at all, warpage when exposed to high and low humidity at high and low temperatures.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an outdoor article;

FIG. 2 is an exploded view of the outdoor article shown in FIG. 1;

FIG. 3 is a cross-sectional view of a first embodiment of a multilayered, substantially planar skin; and

FIG. 4 is a cross-sectional view of a second embodiment of a multilayered, substantially planar skin.

### DETAILED DESCRIPTION OF THE INVENTION

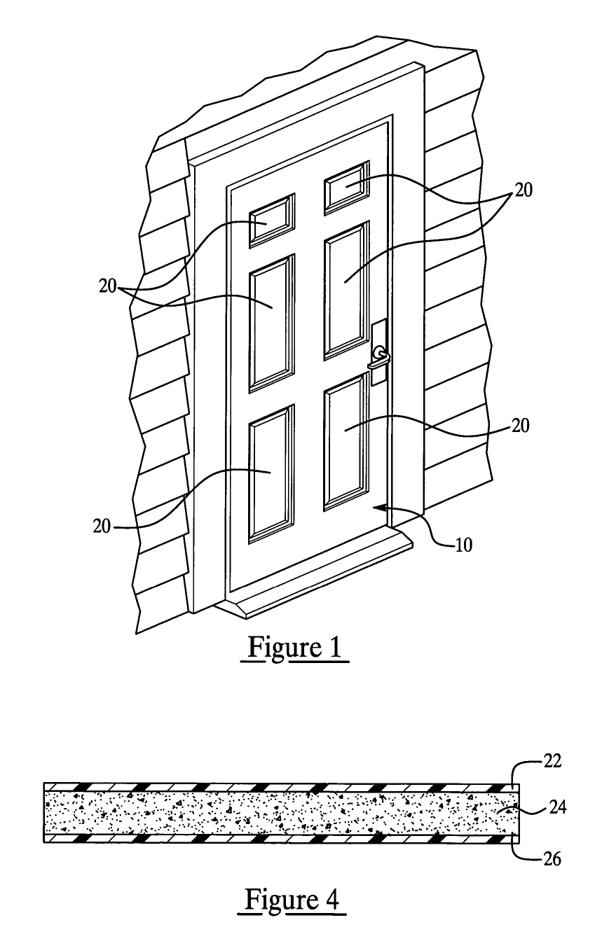

Referring to the Figures, wherein like numerals indicate corresponding parts throughout the several views, an article having a multilayered, substantially planar skin 12 secured thereto is shown generally at 10. The article 10 is exposed to various environmental conditions, such as those encountered by an outdoor article. The article 10 may include an exterior door, an exterior garage door, or the like. It is to be appreciated by those of ordinary skill in the art that the article 10 may include various other articles commonly found on buildings, such as shutters, decorative headers, and the like. The article 10 is illustrated in FIG. 1 as an exterior door.

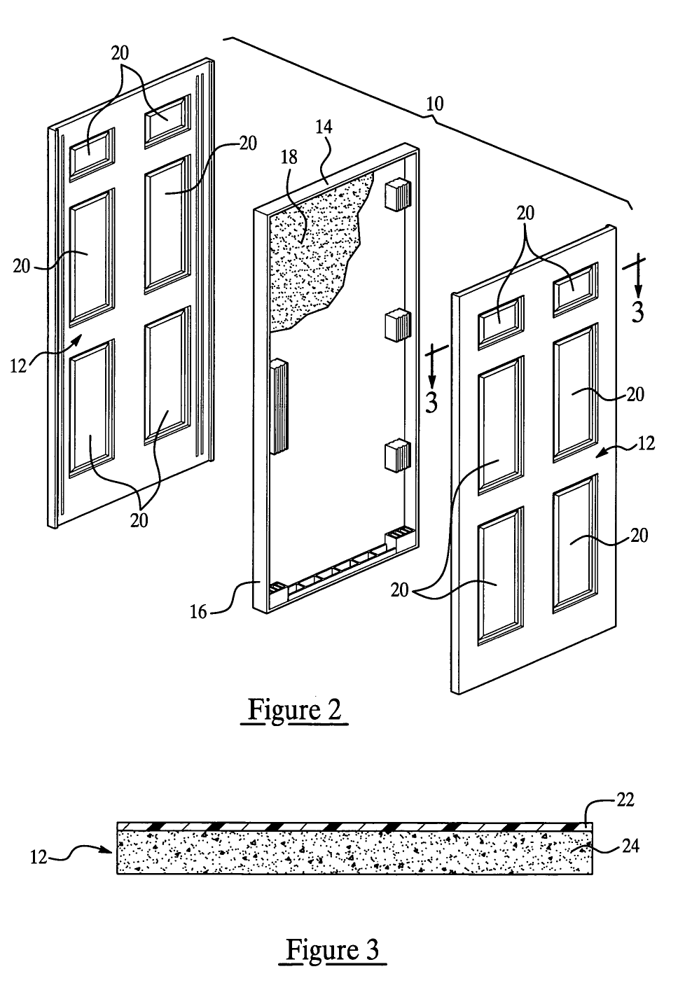

Referring to FIG. 2, an exploded view of the article 10 is shown. The article 10 includes a frame 14 having an outer periphery 16. The frame 14 may be hollow such that a polyurethane foam 18 may be disposed within the frame 14. The multilayered skin 12 is secured to the frame 14 by methods known to those skilled in the art, such as by using adhesives or by forming the polyurethane foam 18 in contact with the multilayered skin 12 to bond therewith. Alternatively, fasteners (not shown) may also be used to secure the multilayered skin 12 to the frame 14.

Generally, most regions are subjected to varying environmental conditions, such as high temperatures and humidity in summer seasons and low temperatures and humidity in winter seasons. Therefore, the articles 10 must be able to withstand these dramatic changes without warping, cracking, or suffering other damage. More importantly, the multilayered skin 12 must be able to withstand such environmental conditions.

The multilayered, substantially planar skin 12 will be referred to hereinafter as the multilayered skin or the skin. The skin 12 may include common decorative features, such as paneling, indentations, or the like, while still being substantially planar. FIGS. 1 and 2 illustrate the skin 12 having panels 20 formed therein. By substantially planar and in relation to certain particular embodiments of the subject invention, it is intended that the skin 12 is generally in sheet-form. Said another way, the skin 12 does not enclose or circumscribe a void itself apart from other skins. Examples of skins that do circumscribe a void are one skin that is shaped like a circle, one skin that is shaped like a square or rectangle, or similar geometrical shapes that circumscribe a void and are generally formed in a continuous extrusion process in these specific shapes. Thus, these skins are not substantially planar as presented in the subject invention. In FIG. 2, the article 10 includes one skin secured to the front of the frame 14 and another skin secured to the back of the frame 14 such that the two skins enclose the frame 14.

The skin 12 comprises a first layer 22 exposed to the environmental conditions and a second layer 24 shielded from the environmental conditions by the first layer 22. Said another way, the first layer 22 is disposed onto the second layer 24. For example, one method of forming the skin 12 is by coextruding the first and second layers 22, 24 with the first layer 22 in contact with the second layer 24 as a sheet.

A cross-sectional view of a first embodiment of the skin 12 is shown in FIG. 3. The multilayered skin 12 has a total thickness of from about 20 to about 150 mils. Further, the total thickness of the multilayered skin 12 may be from about 50 to about 125 mils or from about 60 to 100 mils. It is to be appreciated that the Figures may not be drawn to scale. The total thickness of the multilayered skin 12 depends upon the desired application and the desired physical properties. The first layer 22 has a thickness of from about 5 to about 25 percent of the total thickness of the multilayered skin 12. Thus, the second layer 24 would have a thickness of from about 95 to about 75 percent of the total thickness of the multilayered skin 12.

The first layer 22 is substantially free of organic and/or inorganic fillers. The term substantially free is intended to mean that the first layer 22 has less than about 2.5 percent based on a total weight of the first layer 22 of the filler. Preferably, the first layer 22 does not include any filler. It is to be appreciated that the first layer 22 may contain additives other than organic and/or inorganic fillers, such as pigments. The first layer 22 comprises a copolymer of at least one ethylenically unsaturated monomer, at least one aromatic vinyl compound, and at least one acrylic ester elastomer. The copolymer may also be a graft copolymer resin such as are well known in the art.

One example of a suitable ethylenically unsaturated monomer is vinyl cyanide. Vinyl cyanides that may be used with the subject invention include acrylonitrile, methacrylonitrile, alkylacrylates and alkylmethacrylates having from 1 to 4 carbon atoms in the alkyl moiety, acrylic acid, methacrylic acid, maleic anhydride, acrylamide, and/or vinyl methyl ether. Preferably, the vinyl cyanide is acrylonitrile.

The aromatic vinyl compound may be selected from at least one styrene, α-methylstyrene, o-methylstyrene, p-methylstyrene, m-methylstyrene, 1,3-dimethylstyrene, tertbutylstyrene, vinylnaphthalene, and the like may also be used with the subject invention. Preferably, the aromatic vinyl compound is styrene.

The acrylic ester elastomer, commonly referred to as rubber, may be selected from polybutadiene, polyisoprene, styrene-butadiene copolymers, acrylonitrile-butadiene copolymers, alkylacrylate rubbers, EPM rubbers (ethylene/propylene rubbers), EPDM rubbers (ethylene/propylene/diene rubber containing a non-conjugated diene, such as for example 1,5-hexadiene or norbornadiene, in small quantities as the diene,) and silicone rubbers.

The first layer 22 is preferably an ASA resin, i.e., acrylonitrile-styrene polymer (SAN) in combination with the acrylic ester elastomer. As understood by those skilled in the art, the acrylonitrile and the styrene form the acrylonitrile-styrene polymer and then the acrylic ester elastomer may be added thereto to form the copolymer. Other known thermoplastic resins may be used as the first layer 22, such as, olefin-styrene-acrylonitrile (OSA), acrylonitrile-EPDM-styrene resins (AES), or acrylonitrile-butadiene-styrene (ABS).

The acrylonitrile-styrene polymer is present in an amount of from about 40 to about 80 percent based on the total weight of the copolymer. For example, the acrylonitrile-styrene polymer may be present in an amount of from about 45 to about 75 percent or from about 50 to about 70 percent, both based on the total weight of the copolymer. The styrene is present in an amount of at least 20 percent based on the total weight of the acrylonitrile-styrene polymer. The styrene may be present in an amount of from about 30 to about 85 percent or from about 30 to about 75 percent, both based on the total weight of the acrylonitrile-styrene polymer.

The acrylonitrile-styrene polymer may be polymerized by traditional processes known to those skilled in the art. Polymerization may be carried out in mass, solution, suspension, or aqueous emulsion. One preferred process is by free radical polymerization.

Those skilled in the art will appreciate that the acrylic ester elastomer, commonly referred to as rubber, may result from the polymerization or copolymerization of one or more monomers selected from the group consisting of (i) alkyl acrylates having from 1 to 8 carbon atoms in the alkyl group, (ii) a 1,3 diene, (iii) olefin compounds, (iv) ethylenically unsaturated compounds, (v) aromatic vinyl compounds, (vi) polyfunctional monomers having a cross linking effect, and (vii) mixtures thereof. Preferred are alkyl acrylates having from 4 to 8 carbons in the alkyl moiety. Most preferred examples are n-butyl acrylate and ethylhexyl acrylate. These monomers can be one or more alkyl acrylates alone or in admixture with one another. One preferred example of the copolymer forming the first layer 22 is LURAN® S ASA resin available from BASF Corporation, Wyandotte, Mich.

The acrylic ester elastomer may be made by polymerization processes known to those skilled in the art. Such processes include, without being limited thereto, emulsion polymerization and bulk or solution polymerization followed by emulsification of the resulting polymers.

The second layer 24 comprises a terpolymer of at least one ethylenically unsaturated monomer, at least one butadiene, and at least one aromatic vinyl compound. For efficient processing of the skin 12, the second layer 24 may have a melt volume rate of less than 12 cm³ per 10 minutes when subjected to a 10 Kg weight at 220 degrees Celsius in accordance with ASTM D1238. The ethylenically unsaturated monomer and the aromatic vinyl compound may be same as those described above in connection with the ASA resin. Butadiene is an ethylenically unsaturated monomer and may be selected from isoprene, 1,3-butadiene, or any other known divinyl compounds.

In the preferred embodiment, the second layer 24 is formed from the ABS resin. The ABS resin may include the acrylonitrile-styrene polymer described above blended with the terpolymer of acrylonitrile, butadiene, and styrene. The acrylonitrile-styrene polymer is present in an amount of from about 60 to about 80 percent based upon the total weight to the second layer 24. The terpolymer is present in an amount of from about 40 to about 20 percent based upon the total weight to the second layer 24. One preferred example of the terpolymer forming the second layer 24 is TERLURAN® GP-22 ABS resin available from BASF Corporation, Wyandotte, Mich.

In order to provide adequate physical properties, at least one filler is dispersed in the second layer 24 in an amount of from about 5 to about 35 percent based on a total weight of the second layer 24. For example, the filler may be present in an amount of from about 10 to about 30 percent based on the total weight of the second layer 24. Even though the first layer 22 is substantially free of fillers, since the first and second layers 22, 24 contact one another; the fillers from the second layer 24 may exude into the first layer 22. If this does occur, the first layer 22 is still to be considered substantially free of fillers. Suitable examples of fillers include glass fibers, wood fibers, flower fibers, carbon fibers, mica, talc, wollastonite, glass beads, and micro-spheres. The filler may be an organic filler and/or an inorganic filler.

The filler may further comprise a first filler and a second filler different than the first filler. The first filler is present in an amount of from about 1 to about 34 percent based on a total weight of the second layer 24 and the second filler is present in an amount of from about 1 to about 34 percent based on a total weight of the second layer 24. Preferably, the first filler has reinforcing characteristics in one or two directions and the second filler has reinforcing characteristics in two or three directions. It is to be appreciated that by those of ordinary skill in the art, that “reinforcing characteristics” means providing strength to the second layer 24.

For example, the first filler may be selected from at least one of a fiber, a platelet, and a flake, wherein the fiber has one dimensional reinforcing characteristics and wherein the platelet and the flake have two dimensional reinforcing characteristics. The second filler may be selected from at least one of a platelet, a flake, a bead and a micro-sphere. The platelet and the flake have two dimension reinforcing characteristics and the bead and the micro-sphere have three dimensional reinforcing characteristics. Said another way, if the first filler is a fiber, those skilled in the art recognize that the fiber provides support along the length of the fiber, i.e. in one dimension. If the first filler is a flake, then the support is provided by the length and width, i.e. in two dimensions. If the second filler is a bead, then the support is provided by the length, width, and thickness, i.e. in three dimensions.

Referring to FIG. 4, a cross-sectional view of a second embodiment of the multilayered skin 12 is illustrated. In addition to the first and the second layers 22, 24, the multilayered skin 12 comprises a third layer 26 substantially free of organic and/or inorganic fillers disposed in contact with the second layer 24 and opposite the first layer 22. The first, second, and third layers 22, 24, 26 are co-extruded substantially parallel to one another forming a substantially planar surface such that the second layer 24 is disposed between the first and the third layers 22, 26.

In this embodiment, the multilayered skin 12 may still have a total thickness of from about 20 to about 150 mils. The third layer 26 has a thickness of from about 5 to about 25 percent of the total thickness of the multilayered skin 12. The combined thickness of the first and the third layers 22, 26 would likely not exceed about 25 percent of the total thickness to ensure that the skin 12 has adequate physical properties. For example, both the first and the third layers 22, 26 may have a thickness of about 10 percent of the total thickness and the second layer 24 would have a thickness of about 80 percent of the total thickness. As another example, the first layer 22 may have a thickness of about 15 percent of the total thickness and the third layer 26 may have a thickness of about 10 percent of the total thickness. The second layer 24 would then have a thickness of about 75 percent of the total thickness.

The third layer 26 is selected from at least one of the ASA resin or the ABS resin described above or polycarbonate. The third layer 26 may be any type of plastic material that is free of fillers in order to protect the processing equipment, such as SAN, OSA, or AES. It has been discovered that even though the first and second layers 22, 24 provide a satisfactory skin 12, the high filler content of the second layer 24 results in increased wear on the manufacturing equipment. Therefore, the third layer 26 protects the manufacturing equipment from excessive wear due to the filler in the second layer 24. Additionally, the third layer 26 provides additional physical properties to the article 10.

The multilayered skin 12 may be formed with other well known additives to aid in improved weathering performance, manufacturing, or esthetics. For example, each of the layers may contain pigments. The pigment may consist of inorganic or organic compounds. The most widely used white pigment is the crystal form of titanium dioxide (TiO₂). Other white pigments are zinc oxide (ZnO), zinc sulfide (ZnS), barium sulfate (BaSO₄), and lithopone. Some commonly used color pigments are copper phthalocyanine-based greens and blues, quinacridone red, iron oxide red, iron oxide yellow, dirarylide yellow, perinone orange, indanthrene blue, cromophthal red, irgazine orange, and heliogen green. The pigment may be present in an amount of up to 15% based on the total weight of the respective layer. For example, the first layer may have a minimum of 5% pigment based on the total weight of the first layer and the second layer may have 0% pigment based on the total weight of the second layer.

The multilayered, substantially planar skin 12 formed according to the subject invention has a coefficient of linear thermal expansion (CLTE) of from about 1.0×10⁻⁵ to about 5.0×10⁻⁵ per degree Celsius in accordance with ASTM D696. Existing fiberglass articles, as discussed in the Background of the Invention, have a CLTE of about 2.1×10⁻⁵ per degree Celsius and therefore it is desirous that the subject invention perform as well as the related art articles in thermal performance. The CLTE of the skin 12 of the subject invention may be higher than that of the fiberglass article while still outperforming the fiberglass article in stability when exposed to various environmental conditions, such as humidity.

The following examples, illustrating the formation of the multilayered, substantially planar skin 12 according to the subject invention and illustrating certain properties of the skin 12 and article 10, as presented herein, are intended to illustrate and not limit the invention.

### EXAMPLES

A multilayered, substantially planar skin 12 was formed having the layers shown in Table 1. Example 1 was formed utilizing a co-extrusion process. Comparative Examples 1 and 2 are skins having a single layer, and Comparative Example 3 is multilayered skin having the foam core as the second layer, however, the three layers are not co-extruded. For Example 1 and the Comparative Examples, the total thickness was about 85 mils.

One typical process for forming the skins of Example 1 and Comparative Examples 2 and 3 is an extrusion of ASA/ABS thermoplastics. The process may include pre-drying the resins to remove surface moisture. Then, the dried pellets are fed into a conventional single-screw main extruder for production of the monolayer sheet or the second layer of a co-extruded or a tri-extruded sheet. For a co-extruded or a tri-extruded sheet, the dried pellets are also fed into a conventional single-screw side extruder. The extruder temperature zones are typically set between 204-238° C. The actual temperatures will vary depending on the extruder design. The ASA and/or ABS materials are extruded through a die to form the desired composite sheet structure. The sheet is polished to the desired surface finish using standard roll stack equipment. The roll stack temperatures are typically set between 65.5-99° C. Standard sheet processing equipment is used to cut the sheet to the appropriate size.

One typical process for forming the skin of Comparative Example 1 is compression molding. A thermoset resins charge is placed onto the bottom platen of a 2-piece mold mounted in a press. The mold temperature is typically 120-180° C. The press closes and the SMC resins flows to fill the cavity and then reacts to form the skin. The mold is vented to allow air/gas to escape. After 50-90 seconds, the mold opens and the skin is removed. Excess flash is then removed from the skin.

TABLE 1
Skins for securing to the Article 10

| | Ex. 1 | Comp. Ex. 1 | Comp. Ex. 2 | Comp. Ex. 3 |
|---|---|---|---|---|
| # of Layers | 3 | 1 | 1 | 3 |
| First layer | ASA/10 mils | Fiberglass/85 | ASA/85 mils | ASA/10 mils |
| Type/Thickness | | mils | | |
| Second layer | ABS 20% | — | — | Foam 18 |
| Type/Thickness | glass/65 mils | | | Core/65 mils |
| Third layer | ASA/10 mils | — | — | ASA/10 mils |
| Type/Thickness | | | | |

ASA is LURAN® S 757G ASA resin and ABS is TERLURAN® GP-22 ABS resin, both available from BASF Corporation, Wyandotte, Mich. In Comparative Example 1, the fiberglass is Owens Corning 408A Cratec® Chopped Strands. In Comparative Example 3, the foam core is LURAN® S 757G ASA resin with 1 percent by weight based on a total weight of the foam core of Americhem 17027 E1, which is an exothermic, chemical blowing agent recommended for styrenic polymers.

Each of the skins was then subjected to various physical property tests and the results are shown below in Table 2. For each physical property tested, the well-known test method and standard units are provided.

Once the skins are formed, the article, such as a door assembly, is manufactured. A frame is assembled from wood and/or wood composite materials. Lock blocks and other interior components are attached to the frame. The skins are attached to the frame using a glue or similar adhesive. A hole for the injection of polyurethane foaming chemicals is drilled into the frame. Next, the door assembly is placed in a press. The press platens are heated to 36-60° C. A rigid, polyurethane foam resin system is injected into the door assembly using standard polyurethane processing equipment. The urethane foam density is typically 2.0-2.5 pcf. After 4-6 minutes, the doors are removed from the press. The doors are then ready for shipment or painting.

TABLE 2
Physical Properties of the Skins

| | | | | Comp. | Comp. | Comp. |
|---|---|---|---|---|---|---|
| | Method | Units | Ex. 1 | Ex. 1 | Ex. 2 | Ex. 3 |
| Total Thickness | | mil | 85 | 85 | 85 | 85 |
| Specific Gravity | | | 1.15 | 1.70 | 1.07 | 0.82 |
| MVR | ASTM D | cm³/10 min | 12 | N/A | 21 | 21 |
| | 1238 | | | | | |
| Gardner Impact | ASTM D | in-lbs | 16 | 11 | 140 | 20 |
| | 5420 | | | | | |
| HDT @264 psi - | ASTM D 648 | ° C. | 93 | N/A | 96 | 94 |
| Unannealed | | | | | | |
| CLTE | ASTM D 696 | /° C. | 5 × 10⁻⁵ | 2.1 × 10⁻⁵ | 10 × 10⁻⁵ | 8.2 × 10⁻⁵ |
| Tensile Strength @ | ASTM D 638 | psi | 5500 | 3350 | 5600 | 3350 |
| yield | | | | | | |
| Tensile Modulus | ASTM D 638 | kpsi | 430 | 1260 | 300 | 283 |
| Tensile Strain @ Break | ASTM D 638 | psi | 3.6 | 0.3 | 15 | 10 |
| Flexural Strength @ | ASTM D 790 | psi | 9400 | 5700 | 9500 | 6280 |
| yield | | | | | | |
| Flexural Modulus | ASTM D 790 | kpsi | 420 | 880 | 350 | 235 |
| Notched Izod Impact | ASTM D 256 | ft-lb/in | 0.62 | 2.71 | 1.24 | 0.31 |
| Unnotched Izod Impact | ASTM D 256 | ft-lb/in | 2.19 | 5.47 | NB | N/A |
| Notched Izod @ −20° F. | ASTM D 256 | ft-lb/in | 0.26 | 2.73 | 0.45 | 0.27 |
| Rockwell Hardness | ASTM D | R | 103 | 98.1 | 99.8 | 31 |
| | 785/A | | | | | |

For unnotched izod, “NB” represent “no break.” In other words, the sample tested did not break. In addition to the physical properties of Table 2, each of the skins were subjected to additional stability tests described below. The stiffness of the skin is important when assembling doors. The first stiffness test is a cantilever test that measure the sag of a test specimen when it is allowed to droop off the end of table. The door skin stiffness test is a assessment of how the door skins perform during the assembly process. Also, once the skins were applied to the article 10, the article 10 underwent an impact test. The impact test is a modified Gardner impact test that was performed to assess the impact performance of the door skin when backed with polyurethane foam. Further, polyurethane adhesion was determined for each of the skins by verifying cohesive failure of the skin/foam interface. Each of the skins were also tested for blistering when exposed to a thermal soak test of 48 hours at 71.1° C. It was also important for the subject invention to be able to be stained or painted. Therefore, the Examples were evaluated for paint/stain adhesion using standard, residential latex exterior house paint and stain. The results are listed below in Table 3.

TABLE 3
Additional Properties of the Skins

| | | Comp. | Comp. | Comp. |
|---|---|---|---|---|
| | Ex. 1 | Ex. 1 | Ex. 2 | Ex. 3 |
| Stiffness - Cantilever Sag, % | 7 | 7 | 15 | 12 |
| Door skin Stiffness | Acceptable | Acceptable | Marginal | Marginal |
| Door Impact (skin w/foam), 23° C. | 21 in-lb | 40 in-lb | 360 in-lb | 80 in-lb |
| Foam Adhesion | Good | Good | Good | Good |
| Polyurethane Glue Adhesion | Pass | Pass | Pass | Pass |
| Blistering after foaming | Pass | Pass | Pass | Pass |
| Blistering after t-cycle | Pass | Pass | Pass | Pass |
| Blistering after t-soak | Pass | Pass | Marginal | Marginal |
| Weathering | V. Good | Poor | V. Good | V. Good |
| Stainability | Pass | Pass | Pass | Pass |
| Paintability | Pass | Pass | Pass | Pass |

The door skin stiffness determines the stiffness of the door skin when positioned in a mold prior to blowing the polyurethane core. The door skin is secured to the frame and if the door skin is not sufficiently stiff, the door skin will sag or droop. After the core is formed, if the door skin sagged, the door will be concave because the foam does not have sufficient force to push out the sagging door skin. An acceptable door skin has little or no sag. Foam adhesion refers to cohesive failure at the polyurethane foam and the door skin interface. Said another way, when the door skin is removed, the foam should remain adhered to the door skin and the tear should occur in the polyurethane foam. Polyurethane glue adhesion refers to the adhesion of the adhesive used to secure the door skin to the frame.

Blistering of the door skin is determined after foaming the polyurethane core, after subjecting to thermal cycles, and after subjecting to a thermal soak. A sample passes if no blisters appear on the visible surface and marginally pass if only a few blisters appear. The thermal cycle exposes the sample to temperature rises from ambient to 82.2° C. The thermal soak exposes the sample to a constant temperature of about 60° C. for about 24 hours.

Weathering of the sample is determined using a ΔE analysis, which is known to those skilled in the art as a shift of color when exposed to outdoor environment. A ΔE of less than 2 is very good and a ΔE of over 3 is poor. The stainability and paintability of the sample refers to the ability of the stain/paint to adhere to the door skin.

From the above results, the subject invention performs at least as well as the related art fiberglass skins and articles having the fiberglass skins. Further, the.subject invention outperforms the single layered skins in such properties as CLTE and stiffness.

Obviously, many modifications and variations of the present invention are possible in light of the above teachings. The invention may be practiced otherwise than as specifically described within the scope of the appended claims.

What is claimed is:

1. A multilayered, substantially planar skin for securing to an article exposed to various environmental conditions, said skin comprising:
a first layer exposed to the environmental conditions and substantially free of organic and/or inorganic fillers and comprising a copolymer of at least one ethylenically unsaturated monomer, at least one aromatic vinyl compound, and at least one acrylic ester elastomer; and
a second layer shielded from the environmental conditions by said first layer and comprising a terpolymer of at least one ethylenically unsaturated monomer, at least one butadiene, and at least one aromatic vinyl compound and having at least one filler dispersed therein in an amount of from about 5 to about 35 percent based on a total weight of said second layer for providing increased resistance.

2. A multilayered skin as set forth in claim 1 wherein said ethylenically unsaturated monomer is acrylonitrile and said aromatic vinyl compound is styrene.

3. A multilayered skin as set forth in claim 2 wherein said butadiene is 1,3-butadiene.

4. A multilayered skin as set forth in claim 1 wherein said multilayered skin has a total thickness of from about 20 to about 150 mils.

5. A multilayered skin as set forth in claim 1 wherein said filler is selected from at least one of an organic filler and an inorganic filler.

6. A multilayered skin as set forth in claim 1 wherein said filler is selected from at least one of glass fibers, wood fibers, flower fibers, carbon fibers, mica, talc, wollastonite, glass beads, and micro-spheres.

7. A multilayered skin as set forth in claim 1 wherein said filler comprises a first filler present in an amount of from about 1 to about 34 percent based on a total weight of said second layer and a second filler different than said first filler and present in an amount of from about 1 to about 34 percent based on a total weight of said second layer.

8. A multilayered skin as set forth in claim 7 wherein said first filler has reinforcing characteristics in one or two directions and said second filler has reinforcing characteristics in two or three directions.

9. A multilayered skin as set forth in claim 8 wherein said first filler is selected from at least one of a fiber, a platelet, and a flake, wherein said fiber has one dimensional reinforcing characteristics and wherein each of said platelet and said flake has two dimensional reinforcing characteristics.

10. A multilayered skin as set forth in claim 8 wherein said second filler is selected from at least one of a platelet, a flake, a bead, and a micro-sphere, wherein each of said platelet and said flake has two dimensional reinforcing characteristics and wherein each of said bead and said micro-sphere has three dimensional reinforcing characteristics.

11. A multilayered skin as set forth in claim 1 wherein said first layer has a thickness of from about 5 to about 25 percent of said total thickness of said multilayered skin.

12. A multilayered skin as set forth in claim 1 further comprising a third layer substantially free of organic and/or inorganic fillers and disposed in contact with said second layer opposite said first layer.

13. A multilayered skin as set forth in claim 12 wherein said first, second, and third layers are co-extruded substantially parallel to one another forming a substantially planar surface.

14. A multilayered skin as set forth in claim 13 wherein said second layer is disposed between said first and said third layers.

15. A multilayered skin as set forth in claim 12 wherein said third layer comprises at least one of a copolymer of at least one ethylenically unsaturated monomer, at least one aromatic vinyl compound, and at least one acrylic ester elastomer; a terpolymer of at least one ethylenically unsaturated monomer, at least one butadiene, and at least one aromatic vinyl compound; and polycarbonate.

16. A multilayered skin as set forth in claim 12 wherein said second layer is disposed in contact with said first layer and said third layer is disposed in contact with said second layer.

17. A multilayered skin as set forth in claim 15 wherein said third layer has a thickness of from about 5 to about 25 percent of said total thickness of said multilayered skin.

18. A multilayered skin as set forth in claim 1 having a coefficient of linear thermal expansion of from about 1.0×10⁻⁵ to about 5.0×10⁻⁵ per degree Celsius in accordance with ASTM D696.

19. A multilayered skin as set forth in claim 1 wherein said second layer has a melt volume rate of less than 12 cm³ per 10 minutes when subjected to a 10 Kg weight at 220 degrees Celsius in accordance with ASTM D1238.

20. A multilayered skin as set forth in claim 1 wherein said first and said second layers are co-extruded with said first layer disposed on top of said second layer.

21. An article exposed to various environmental conditions, said outdoor article comprising:
a frame having an outer periphery;
at least one multilayered, substantially planar skin secured to said frame and comprising a first layer exposed to the environmental conditions disposed on top of a second layer shielded from the environmental conditionals by said first layer;
said first layer substantially free of organic and/or inorganic fillers comprising a copolymer of at least one ethylenically unsaturated monomer, at least one aromatic vinyl compound, and at least one acrylic ester elastomer;
said second layer comprising a terpolymer of at least one ethylenically unsaturated monomer, at least one butadiene, and at least one aromatic vinyl compound and having at least one filler dispersed within said second layer in an amount of from about 5 to about 35 percent based on a total weight of said second layer; and
wherein said multilayered skin has a total thickness of from about 20 to about 150 mils.

22. An article as set forth in claim 21 wherein said ethylenically unsaturated monomer is acrylonitrile and said aromatic vinyl compound is styrene.

23. An article as set forth in claim 22 wherein said butadiene is 1,3-butadiene.

24. An article as set forth in claim 21 wherein said filler is selected from at least one of an organic filler and an inorganic filler.

25. An article as set forth in claim 21 wherein said filler is selected from at least one of glass fibers, wood fibers, flower fibers, carbon fibers, mica, talc, wollastonite, glass beads, and micro-spheres.

26. An article as set forth in claim 21 wherein said filler further comprises a first filler present in an amount of from about 1 to about 34 percent based on a total weight of said second layer and a second filler different than said first filler and present in an amount of from about 1 to about 34 percent based on a total weight of said second layer.

27. An article as set forth in claim 26 wherein said first filler has reinforcing characteristics in one or two directions and said second filler has reinforcing characteristics in two or three directions.

28. An article as set forth in claim 27 wherein said first filler is selected from at least one of a fiber, a platelet, and a flake, wherein said fiber has one dimensional reinforcing characteristics and wherein each of said platelet and said flake has two dimensional reinforcing characteristics.

29. An article as set forth in claim 27 wherein said second filler is selected from at least one of a platelet, a flake, a bead, and a micro-sphere, wherein each of said platelet and said flake has two dimensional reinforcing characteristics and wherein each of said bead and said micro-sphere has three dimensional reinforcing characteristics.

30. An article as set forth in claim 21 wherein said first layer has a thickness of from about 5 to about 25 percent of said total thickness of said multilayered skin.

31. An article as set forth in claim 21 further comprising a third layer substantially free of organic and/or inorganic fillers disposed in contact with said second layer and opposite said first layer.

32. An article as set forth in claim 31 wherein said first, second, and third layers are co-extruded substantially parallel to one another and form a substantially planar surface.

33. An article as set forth in claim 31 wherein said third layer comprises at least one of a copolymer of at least one ethylenically unsaturated monomer, at least one aromatic vinyl compound, and at least one acrylic ester elastomer; a terpolymer of at least one ethylenically unsaturated monomer, at least one butadiene, and at least one aromatic vinyl compound; and polycarbonate.

34. An article as set forth in claim 31 wherein said third layer has a thickness of from about 5 to about 25 percent of said total thickness of said multilayered skin.

35. An article as set forth in claim 21 wherein said multilayered skin has a coefficient of linear thermal expansion of from about 1.0×10⁻⁵ per degree Celsius to about 5.0×10⁻⁵ per degree Celsius in accordance with ASTM D696.

36. An article as set forth in claim 21 wherein said second layer has a melt volume rate of less than 12 cm³ per 10 minutes when subjected to a 10 Kg weight at 220 degrees Celsius in accordance with ASTM D1238.

37. A multilayered skin exposed to various environmental conditions, said skin comprising:
a first layer exposed to the environmental conditions and substantially free of organic and/or inorganic fillers and comprising a copolymer of at least one ethylenically unsaturated monomer, at least one aromatic vinyl compound, and at least one acrylic ester elastomer;
a second layer shielded from the environmental conditions by said first layer and comprising a terpolymer of at least one ethylenically unsaturated monomer, at least one butadiene, and at least one aromatic vinyl compound;
a first filler having reinforcing characteristics in one or two directions and present in an amount of from about 1 to about 34 percent based on a total weight of said second layer; and
a second filler different than said first filler and having reinforcing characteristics in two or three directions and present in an amount of from about 1 to about 34 percent based on a total weight of said second layer.

38. A multilayered skin as set forth in claim 37 wherein said first filler is selected from at least one of a fiber, a platelet, and a flake, wherein said fiber has one dimensional reinforcing characteristics and wherein each of said platelet and said flake has two dimensional reinforcing characteristics.

39. A multilayered skin as set forth in claim 37 wherein said second filler is selected from at least one of a platelet, a flake, a bead, and a micro-sphere, wherein each of said platelet and said flake has two dimensional reinforcing characteristics and wherein each of said bead and said micro-sphere has three dimensional reinforcing characteristics.
